(19) United States
(12) Patent Application Publication
(10) Pub. No.: US 2014/0345627 A1
(43) Pub. Date: Nov. 27, 2014

(54) HELMET MOISTURE CONTROL SYSTEM

(71) Applicant: JOHN N. YOUNTS, LEESBURG, VA (US)

(72) Inventor: JOHN N. YOUNTS, LEESBURG, VA (US)

(21) Appl. No.: 13/902,656

(22) Filed: May 24, 2013

(51) Int. Cl. A42B 3/24; A62B 9/00; A62B 9/02; A63B 71/08

(52) U.S. Cl. CPC A42B 3/24; A63B 71/085; A62B 9/003; A62B 9/02; A63B 2071/086
USPC 128/861

(57) ABSTRACT

The helmet moisture control system prevents or greatly reduces moisture accumulation in the volume between the face of a helmet wearer and the transparent face shield when wearing a closed face helmet. The system includes a mouth guard having a breathing passage therethrough connected to a central body having separate inhalation and exhalation tubes extending therefrom. A flapper valve in the central body closes the exhalation tube when the wearer inhales, and closes the inhalation tube when the wearer exhales. Exhaled air and accompanying moisture are prevented from entering the volume between the helmet wearer's face and the helmet face shield so long as the wearer breathes orally, thereby greatly assisting in preventing fogging of the interior of the face shield. A moisture condensation trap and drain are provided at the lower portion of the central body. A filter may be provided at the inlet end of the inhalation tube.

### BACKGROUND OF THE INVENTION

1. Field of the Invention

The present invention relates generally to breathing systems and devices, and more particularly to a helmet moisture control system that expels the exhaled breath and accompanying moisture from a person wearing a closed face helmet to preclude the fogging of the face shield of the helmet.

2. Description of the Related Art

Full face or closed face helmets have become increasingly popular among operators of motorcycles, all-terrain vehicles, and performance and competition vehicles of various sorts. Indeed, many sanctioning bodies of various events require such closed face helmets due to the additional safety margin provided. Such closed helmets may also greatly reduce the amount of dirt, dust, and other foreign matter that might be inhaled by a person operating a vehicle in a very dusty or dirty environment.

However, such closed face helmets have their drawbacks. As the front of the helmet is closed by a transparent face shield or faceplate, the wearer of the helmet is exhaling directly into the enclosed volume between the helmet wearer's face and the face shield. While many attempts have been made to route the exhalations of the helmet wearer out of the helmet, these attempts have been half measures at best. Generally, the exhaled breath and accompanying moisture of the helmet wearer are exhaled directly into the volume between the wearer's face and the face shield of the helmet. While this volume is not completely sealed from the external environment, relatively free flow and circulation of air are at least somewhat restricted with such helmets.

This can result in an increase in humidity within the volume between the helmet wearer's face and the face shield of the helmet. In certain instances, particularly when the face shield is cooled or chilled by cooler air or perhaps precipitation, this can result in the helmet wearer's exhaled moisture condensing on the interior of the face shield and obstructing the vision of the wearer. In many cases it does not require a large temperature difference between the exterior ambient air and the air between the face shield and the helmet wearer's face, as the relative humidity can build up to a rather high level in that volume. The result is obviously hazardous, as the helmet wearer cannot readily clear the interior surface of the face shield without lifting the shield for access to its interior surface. Aside from the exposure of the helmet wearer's face to the elements when the wearer must lift the face shield, the distraction of performing such a procedure while operating a motor vehicle to its limits is clearly a potential safety hazard.

Thus, a helmet moisture control system solving the aforementioned problems is desired.

### SUMMARY OF THE INVENTION

The helmet moisture control system generally comprises separate inhalation and exhalation tubes and a single flapper valve controlling airflow to and from the inhalation and exhalation tubes. A mouth guard or protector includes an air passage therethrough, enabling the helmet wearer to breathe orally while the guard protects the wearer's teeth and mouth structure in the event of a facial impact accident. Inhaled air passes through a tube to a central body containing the flapper valve, the valve deflecting to close an exit port in the body when inhalation occurs. A filter may be provided at the inlet end of the inlet tube, if desired. When the helmet wearer exhales, the valve deflects to close the inlet tube and route the exhalation outward through another tube. When the device is worn with a closed face helmet, the wearer does not exhale his or her moisturized breath into the volume between the helmet wearer's face and the face shield, so long as the helmet wearer breathes orally. Thus, moisturized air is not introduced into the volume between the helmet wearer's face and the face shield of the helmet, thereby keeping the air within that volume dry and precluding or greatly reducing the chance of fogging of the internal surface of the face shield of the helmet. A moisture condensation trap and drain plug are provided at the lower end of the central body, below the flapper valve.

These and other features of the present invention will become readily apparent upon further review of the following specification and drawings.

### BRIEF DESCRIPTION OF THE DRAWINGS

FIG. 1 is an exploded perspective view of a helmet moisture control system according to the present invention, illustrating its various components and their relationship to a closed face helmet.

FIG. 2 is a front perspective view of a helmet moisture control system according to the present invention, the central body of the system being shown broken away to illustrate the internal valve and the helmet being shown in broken lines.

FIG. 3 is a right side elevation view a helmet moisture control system according to the present invention, primarily showing the exhalation tube, the helmet being shown in broken lines.

Similar reference characters denote corresponding features consistently throughout the attached drawings.

### DETAILED DESCRIPTION OF THE PREFERRED EMBODIMENTS

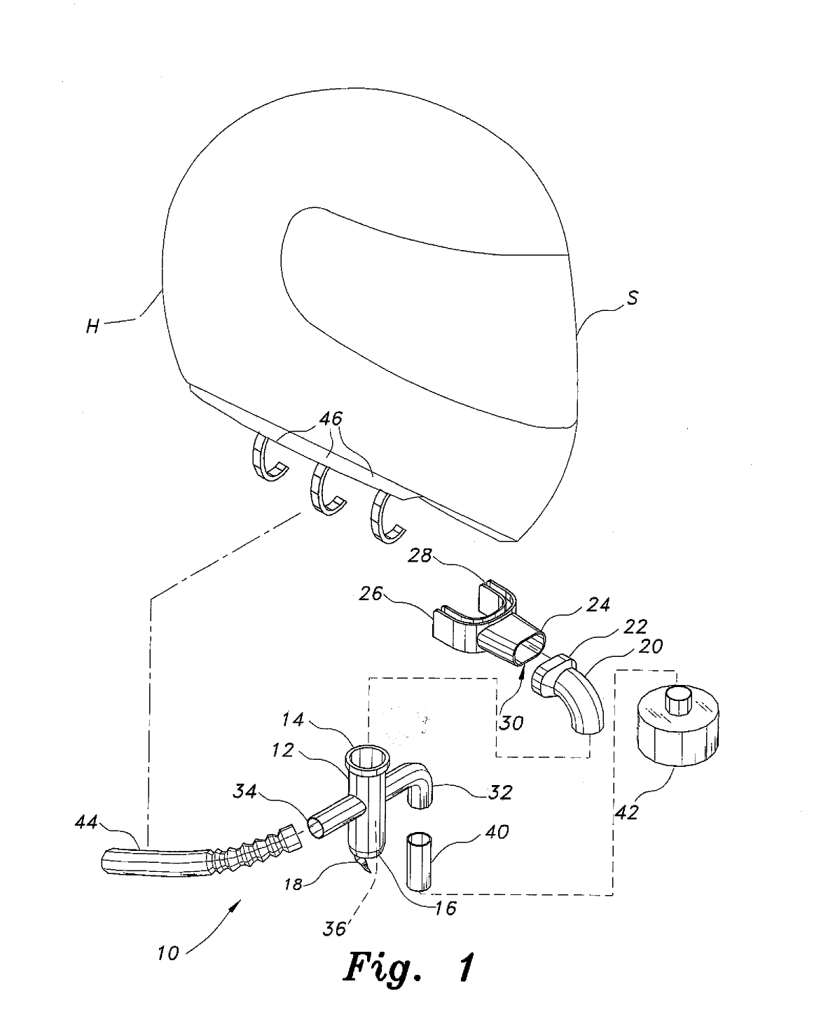

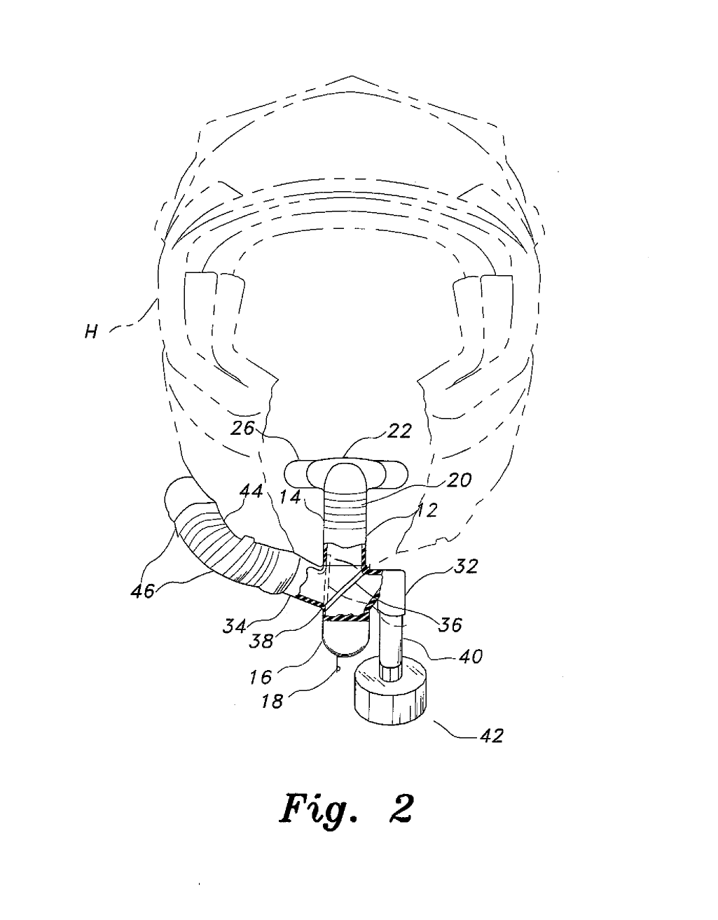

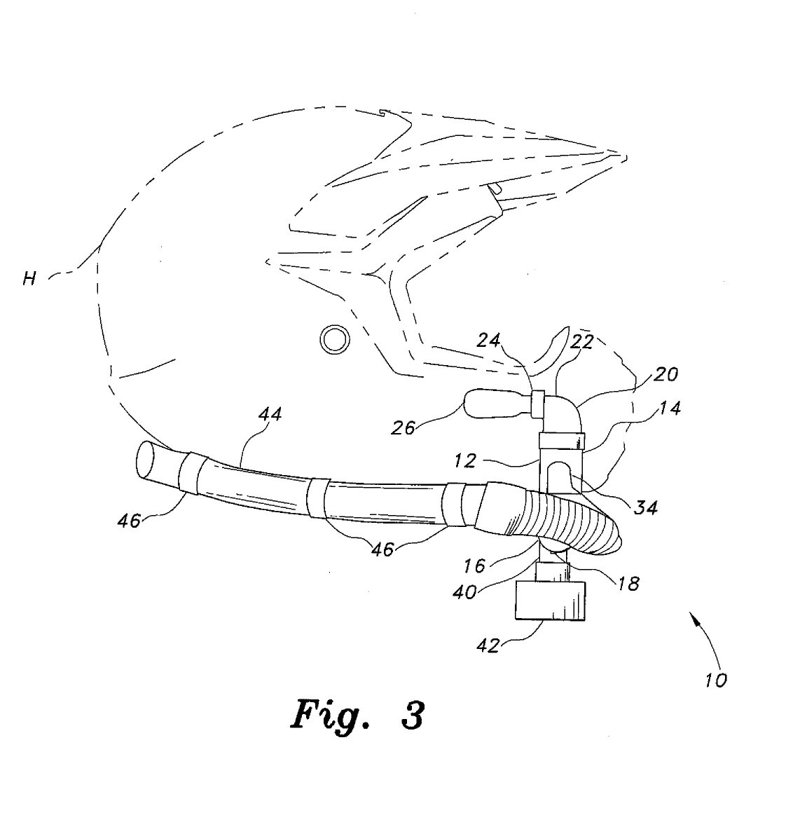

The helmet moisture control system may be used with a conventional closed face helmet having a face shield to remove the exhaled breath and accompanying moisture from the volume between the face of the helmet wearer and the face shield. FIG. 1 of the drawings provides an exploded perspective view of the basic components of the moisture control system 10 and their relationships to one another and to a conventional closed face helmet H with its face shield S. The moisture control system 10 includes a hollow tubular central body 12 having an open upper end 14 and an opposite lower, generally closed condensation trap end 16. A selectively openable drain valve 18, e.g., a soft, pliable plastic component, is provided at the lower moisture condensation trap end 16 of the central body 12 to allow the user to drain condensation from the device as needed. The drain valve 18 is shown in its open position in FIGS. 1 and 2, and closed in FIG. 3.

An adapter 20 is attached to the open upper end 14 of the central body 12. The adapter 20 has an upper end 22 configured for substantially leakproof attachment to the forward or external end 24 of a mouth guard 26. The adapter may be a friction fit with the central body 12 and mouth guard 26 to provide for disassembly of the components, or one or more of the various components may be permanently secured to one another. The mouth guard 26 includes generally arcuate tooth grip channels therein, the upper channel 28 being shown in FIG. 1. However, the mouth guard 26 performs another function in addition to protecting the mouth and/or teeth of the wearer of the system or apparatus 10, in that the mouth guard 26 further includes an oral breathing passage 30 therethrough. Thus, the person using the system or apparatus 10 is provided with oral protection as well as being able to breath orally through the mouth guard 26.

The central body 12 further includes an inhalation tube 32 extending radially therefrom, and an exhalation tube 34 extending radially therefrom generally diametrically opposite the inhalation tube 32. A generally centrally disposed flapper valve 36 is installed within the central body 12, to control airflow into and from the central body 12. The flapper valve 36 is most clearly shown in FIG. 2, in which the forward portion of the central body 12 is partially broken away to show the valve 36. The flapper valve 36 is hinged or pivotally attached at its lower edge 38 to the inside of the central body 12 at the lower edge of the port for the exhalation tube 34. The valve 36 is loosely attached, enabling it to move freely within the central body 12 according to airflow therethrough. When the person using the system or apparatus 10 inhales, air is drawn through the inhalation tube 32, which causes the flapper valve 36 to be deflected upward to cover the port for the exhalation tube 34 as shown in broken lines in FIG. 2. Conversely, when the user of the apparatus 10 exhales, his or her breath is expelled through the central body 12, causing the flapper valve 36 to drop downward away from the exhalation tube port to cover the opposite port for the inhalation tube 32. Thus, air flows only one way through the inhalation and exhalation tubes, and all exhaled breath and accompanying moisture flows outward through the exhalation tube 34.

There are many situations in which a person using and wearing a full face helmet H and using the helmet moisture control system 10 may be exposed to dusty environments, e.g., off-road motorcycling or four wheel driving, etc. Accordingly, the system or apparatus 10 may be equipped with a filter, if desired. An adapter 40 may be attached to the inhalation tube 32, so that a filter 42 may be attached to the distal end of the adapter 40. This structure provides clearance for the filter 42 from the lower forward portion of the closed face helmet H when the system or apparatus 10 is worn and used therewith. The filter 42 is preferably a HEPA (High Efficiency Particulate Air) type unit, although other filter types and configurations may be used.

The helmet moisture control system or apparatus 10 is intended to be used when the user is also wearing a closed face helmet, e.g., a helmet similar to the exemplary helmets H illustrated in the various drawings. Accordingly, both the helmet H and the system 10 may include mutual attachment means for removably securing the apparatus 10 to the helmet H. The system 10 includes an exhalation extension tube 44 that may be removably or permanently attached to the distal end of the exhalation tube 34. The helmet H may include one or more exhalation tube attachment members 46 extending therefrom. The exhalation tube attachment members 46 may comprise flexible straps having complementary hook and loop fabric material thereon (e.g., Velcro®) or other suitable fasteners. In this manner, the helmet moisture control system or apparatus 10 may be provided with the closed face helmet H and may remain with the helmet H when the system 10 and helmet H are not in use. The exhalation tube attachment members 46 also prevent the exhalation tube extension 44 from moving or flailing about during use due to wind turbulence, rough roads, etc., thereby assisting in providing the helmet wearer and user of the helmet moisture control system or apparatus 10 with greater comfort and fewer distractions while engaged in an activity requiring such a full face or closed face helmet.

It is to be understood that the present invention is not limited to the embodiments described above, but encompasses any and all embodiments within the scope of the following claims.

I claim:

1. A helmet moisture control system, comprising:
a mouth guard having an oral breathing passage extending therethrough;
an inhalation tube pneumatically communicating with the mouth guard; and
an exhalation tube pneumatically communicating with the mouth guard, the exhalation tube being separate from the inhalation tube.

2. The helmet moisture control system according to claim 1, further comprising a moisture condensation trap and selectively openable drain depending from the mouth guard and pneumatically communicating therewith.

3. The helmet moisture control system according to claim 1, further comprising:
a central body depending from the mouth guard, the inhalation tube and the exhalation tube pneumatically communicating with the central body; and
an automatic flapper valve disposed within the central body, the flapper valve being movable between a position closing the exhalation tube when air is drawn through the inhalation tube and a position closing the inhalation tube when air is expelled through the exhalation tube.

4. The helmet moisture control system according to claim 1, further comprising an air filter connected to the inhalation tube.

5. The helmet moisture control system according to claim 1, further comprising a central body depending from the mouth guard, the inhalation tube and the exhalation tube pneumatically communicating with the central body, the mouth guard, the central body, the inhalation tube, and the exhalation tube each being removably connected to one another.

6. The helmet moisture control system according to claim 1, further comprising a closed face helmet, the mouth guard, the inhalation tube, and the exhalation tube extending into the helmet.

7. The helmet moisture control system according to claim 6, further comprising exhalation tube attachment means depending from the helmet.

8. A helmet moisture control system, comprising:
an oral air inlet having a breathing passage therethrough;
an inhalation tube pneumatically communicating with the oral air inlet;
an exhalation tube pneumatically communicating with the oral air inlet; and
a moisture condensation trap having a selectively openable drain, the trap depending from the oral air inlet and pneumatically communicating therewith.

9. The helmet moisture control system according to claim 8, wherein the oral air inlet comprises a mouth guard.

10. The helmet moisture control system according to claim 8, further comprising:
a central body depending from the oral air inlet, the inhalation tube and the exhalation tube pneumatically communicating with the central body; and
an automatic flapper valve disposed within the central body, the flapper valve being movable between a position closing the exhalation tube when air is drawn through the inhalation tube and a position closing the inhalation tube when air is expelled through the exhalation tube.

11. The helmet moisture control system according to claim 8, further comprising an air filter connected to the inhalation tube.

12. The helmet moisture control system according to claim 8, further comprising a central body depending from the oral air inlet, the inhalation tube and the exhalation tube pneumatically communicating with the central body, the oral air inlet, the central body, the inhalation tube, and the exhalation tube each being removably connected to one another.

13. The helmet moisture control system according to claim 8, further comprising a closed face helmet, the oral air inlet, the inhalation tube, and the exhalation tube extending into the helmet.

14. The helmet moisture control system according to claim 13, further comprising exhalation tube attachment means depending from the helmet.

15. A helmet moisture control system, comprising:
an oral air inlet having an oral breathing passage therethrough;
a central body depending from the oral air inlet;
an inhalation tube pneumatically communicating with the central body and the oral air inlet;
an exhalation tube pneumatically communicating with the central body and the oral air inlet, the exhalation tube being separate from the inhalation tube; and
an automatic flapper valve disposed within the central body, the flapper valve being movable between a position closing the exhalation tube when air is drawn through the inhalation tube and a position closing the inhalation tube when air is expelled through the exhalation tube.

16. The helmet moisture control system according to claim 15, wherein the oral air inlet comprises a mouth guard.

17. The helmet moisture control system according to claim 15, further comprising a moisture condensation trap and selectively openable drain depending from the oral air inlet and pneumatically communicating therewith.

18. The helmet moisture control system according to claim 15, further comprising an air filter connected to the inhalation tube.

19. The helmet moisture control system according to claim 15, wherein the oral air inlet, the central body, the inhalation tube, and the exhalation tube are each removably connected to one another.

20. The helmet moisture control system according to claim 15 further comprising a closed face helmet, the oral air inlet, the inhalation tube, and the exhalation tube extending into the helmet, the helmet further including exhalation tube attachment means depending therefrom.
